(19) United States
(12) Patent Application Publication
(10) Pub. No.: US 2015/0109358 A1
(43) Pub. Date: Apr. 23, 2015

(54) ELECTRONIC DISPLAY DEVICE

(71) Applicant: Plastic Logic Limited, Cambridge, Cambridgeshire (GB)

(72) Inventors: Jeremy Hills, St Neots (GB); Will Reeves, Willingham (GB)

(21) Appl. No.: 14/403,134

(22) PCT Filed: May 20, 2013
(86) PCT No.: PCT/GB2013/051294

§ 371 Date: Nov. 21, 2014

(30) Foreign Application Priority Data
May 23, 2012 (GB) 1209300.1

(51) Int. Cl. G09G 3/20; G09G 3/34

(52) U.S. Cl. CPC G09G 3/2003; G09G 3/344; G09G 2320/0233; G09G 2320/0238; G09G 2320/0242
USPC 345/694; 345/107

(57) ABSTRACT

The present invention relates to electronic reading devices, a display driver, a method of driving a display and a method of reducing degradation of a pixel value in a display driven to display a target image. A target image is received, and a pixel influence value for each of the pixels in the target image is determined. A compensation image is generated using the pixel influence value for each of the pixels in the target image, where the compensation image comprising pixel compensation value data for a plurality of pixels in the compensation image, and where the pixel compensation value data representing a colour for a pixel in the compensation image. A display compensation drive signal is then generated using the compensation image and the display driven using the display compensation drive signal to display the compensation image to reduce the degradation in a pixel value.

### FIELD OF THE INVENTION

The present invention relates to electronic display devices. In particular, the present invention relates to a display driver, a method of driving a display and a method of reducing degradation of a pixel value in a display driven to display a target image.

### BACKGROUND OF THE INVENTION

In electronic devices having an electronic display to display content, it is often the case that the display driving scheme involves determining the correct drive signals to apply to each pixel in the display depending on the target image to be shown on the display. In some display technologies, for example electrophoretic displays (so-called electronic paper), the current colour or state of each pixel in the display needs to be taken into account when generating the correct driving signal.

It has been observed that in some display technologies (notably, but not necessarily limited to, electrophoretic displays), some pixels are “bullied” by surrounding pixels. That is, despite a pixel being driven to a particular pixel value representing a desired colour, shade of grey, white or black, some pixels appear to be influenced by the surrounding pixels. For example, this means that a white pixel can turn out less bright (i.e. more of a grey), and a black pixel can turn out less dark (i.e. more grey).

In monochrome displays, this has not always been a problem, since a degradation in the pixel value caused by surrounding pixels will manifest in a displayed target image having slightly less contrast, or the edges of fonts may appear slightly blurred or smeared (sometimes this effect is even desirable, to give softer edges to the particular font).

However, as more display technologies move from monochrome to colour, the problem is more apparent as the degradation in pixel value can manifest in colour bleed between pixels. Clearly, this is less desirable.

We have therefore appreciated the need for an improved display driver and a method of reducing degradation of a pixel value caused by surrounding pixel values.

### SUMMARY OF THE INVENTION

The present invention therefore provides a method of reducing degradation in a pixel value in a display that is driven to display a target image, comprising the steps of: receiving a target image comprising pixel value data for a plurality of pixels in the target image, the pixel value data defining a desired pixel value representing a colour for a pixel in the target image; determining a pixel influence value for each of the pixels in the target image from the pixel value data; generating a compensation image using the pixel influence value for each of the pixels in the target image, the compensation image comprising pixel compensation value data for a plurality of pixels in the compensation image, the pixel compensation value data representing a colour transition for a pixel in the compensation image; generating a display compensation drive signal using the compensation image; and driving a display using the display compensation drive signal to display the compensation image to reduce the degradation in a pixel value.

Advantageously generating a compensation image allows for the pixels whose values are influenced by neighbouring pixels to be compensated, thereby reducing the degradation caused by those neighbouring pixels. This method may be performed after sending the target image to a display, or prior to a target image being sent to the display i.e. that the method is carried out on the target image before being sent to the display.

In embodiments, the step of determining a pixel influence value comprises: for each pixel, comparing a first target pixel value of the pixel of interest with a second target pixel value of a neighbouring pixel in the target image; and determining a difference between the first target pixel value and the second target pixel value. Preferably, the second target pixel value comprises a mean target pixel value of two or more neighbouring pixels in the target image. The neighbouring pixel may be a pixel that is above, below, to the left or to the right of the pixel of interest.

In some embodiments, the step of generating a compensation image comprises generating an intermediate image using the pixel influence value for each of the pixels in the target image, the intermediate image comprising intermediate pixel value data for a plurality of pixels in the intermediate image, the intermediate pixel value data defining a pixel value representing a colour for a pixel in the intermediate image.

In such embodiments with an intermediate image, the step of generating an intermediate image comprises: comparing the pixel influence value for each pixel with a threshold pixel value; and setting an intermediate pixel value dependent upon the pixel influence value relative to the threshold pixel value.

If the pixel influence value is below a threshold pixel value, the intermediate pixel value is set to a substantially average pixel value between a pixel value representing black and a pixel value representing white. If the pixel influence value is greater than a threshold pixel value and the desired pixel value is whiter, the intermediate pixel value is set to a pixel value representing black. If the pixel influence value is greater than a threshold pixel value and the desired pixel value is more black, the intermediate pixel value is set to a pixel value representing white.

In embodiments, the step of generating a display compensation drive signal comprises: for each pixel in the intermediate image having an intermediate pixel value that is substantially average, setting a null state so that no drive signal is provided. Furthermore, for each pixel in the intermediate image having an intermediate pixel value that represents black or white, a first drive waveform is selected from a plurality of waveforms based on the intermediate pixel value and the pixel influence value. The first drive waveform defines a driving signal to drive a display based on a transition from black or white to a second pixel value dependent on the pixel influence value.

The present invention also provides a method of driving a display to display a target image, comprising: receiving a target image comprising pixel value data for a plurality of pixels in the target image, the pixel value data defining a desired pixel value representing a colour for a pixel in the target image; and reducing degradation in a pixel value in the target image using the above-described method, wherein the compensation drive signal is a display drive signal.

Furthermore, the present invention also provides a method of driving a display to display a target image, comprising: receiving a target image comprising pixel value data for a plurality of pixels in the target image, the pixel value data defining a desired pixel value representing a colour for a pixel in the target image; generating a display drive signal using the target image; driving a display using the display drive signal to display the target image; reducing degradation in a pixel value in the displayed target image using the method according to the above-described method.

In such methods of driving a display, the step of generating a display drive signal using the target image comprises, for each pixel value in the target image: comparing the target image pixel value with a current pixel value being displayed on the display; selecting a drive waveform from a plurality of waveforms for driving a pixel from the current pixel value being displayed on the display to the desired pixel value in the target image.

Preferably, the step of receiving a target image comprises storing the received target image in a frame buffer, and wherein the step of comparing the target image pixel value with the current pixel value comprises comparing the target image pixel value stored in the frame buffer with the current pixel value. Furthermore, the method preferably comprises storing the current pixel value being displayed on the display in a sample buffer, and wherein the step of comparing the target image pixel value with the current pixel value comprises comparing the target image pixel value with the current pixel value stored in the sample buffer.

In all of the above-mentioned methods, the display may be an electrophoretic display. Furthermore, the desired pixel value representing a colour comprises black, white or a shade of grey between black and white.

The present invention further provides a display driver for reducing degradation in a pixel value in a display that is driven to display a target image on a display coupleable to the display driver, the display driver comprising: an input for receiving a target image comprising pixel value data for a plurality of pixels in the target image, the pixel value data defining a desired pixel value representing a colour for a pixel in the target image; an output for outputting a display driving signal to a display coupleable to the display driver to display a compensation image to reduce the degradation in a pixel value; and a processor coupled to the input and output, and configured to generate a compensation image for displaying on a display coupleable to the display driver for reducing the degradation in a pixel value, wherein the processor is configured to: determine a pixel influence value for each of the pixels in a received target image from the pixel value data; generate a compensation image using the pixel influence value for each of the pixels in the target image, the compensation image comprising pixel compensation value data for a plurality of pixels in the compensation image, the pixel compensation value data defining a desired pixel value representing a colour transistion for a pixel in the compensation image; generate a display compensation drive signal using the compensation image; and drive a display coupleable to the display driver using the display compensation drive signal to display the compensation image to reduce the degradation in a pixel value.

In embodiments of the display driver, the processor is configured to generate a compensation image by: for each pixel, comparing a first target pixel value of the pixel of interest with a second target pixel value of a neighbouring pixel in the target image; and determining a difference between the first target pixel value and the second target pixel value. Preferably the second target pixel value comprises a mean target pixel value of two or more neighbouring pixels in the target image. A neighbouring pixel may be a pixel that is above, below, to the left or to the right of the pixel of interest.

In embodiments of the display driver, the processor is configured to generate a compensation image by: generating an intermediate image using the pixel influence value for each of the pixels in the target image, the intermediate image comprising intermediate pixel value data for a plurality of pixels in the intermediate image, the intermediate pixel value data defining a pixel value representing a colour for a pixel in the intermediate image.

In some embodiments of the display driver, the processor is configured to generate an intermediate image by: comparing the pixel influence value for each pixel with a threshold pixel value, and setting an intermediate pixel value dependent upon the pixel influence value relative to the threshold value.

If the pixel influence value is below a threshold pixel value, the processor is configured to set the intermediate pixel value to a substantially average pixel value between a pixel value representing black and a pixel value representing white. If the pixel influence value is greater than a threshold pixel value and the desired pixel value is whiter, the processor is configured to set the intermediate pixel value to a pixel value representing black. If the pixel influence value is greater than a threshold pixel value and the desired pixel value is more black, the processor is configured to set the intermediate pixel value to a pixel value representing white.

In embodiments of the display driver, the processor is configured to generate a display compensation drive signal by: for each pixel in the intermediate image having an intermediate pixel value that is substantially average, setting a null state so that no drive signal is provided. Furthermore, For each pixel in the intermediate image having an intermediate pixel value that represents black or white, selecting a first drive waveform from a plurality of waveforms based on the intermediate pixel value and the pixel influence value. The first drive waveform defines a driving signal to drive a display based on a transition from black or white to a second pixel value dependent on the pixel influence value.

In some embodiments of the display driver, the processor, prior to determining a pixel influence value, is configured to: generate a display drive signal using the target image; drive a display coupleable to the display driver using the display drive signal to display the target image.

In alternative embodiments, the display driver adjusts a target image based on an expected level of influence by the pixel values and generates drive signals for the modified target image.

In embodiments, the processor is configured to generate a display drive signal using the target image by, for each pixel value in the target image: comparing the target image pixel value with a current pixel value being displayed on the display; selecting a drive waveform from a plurality of waveforms for driving a pixel from the current pixel value being displayed on the display to the desired pixel value in the target image.

Preferably, the display driver comprises a frame buffer, wherein the processor is configured to store the received target image in the frame buffer, and wherein the processor is configured to compare the target image pixel value stored in the frame buffer with the current pixel value. Furthermore, the display driver may comprise a sample buffer, wherein the processor is configured to store the current pixel value being displayed on a display coupleable to the display driver in the sample buffer, and wherein the processor is configured to compare the target image pixel value with the current pixel value stored in the sample buffer.

The present invention also provides an electronic display comprising: a display; and the above-described display driver coupled to the display.

In all embodiments, the display may comprise an electrophoretic display. Furthermore, the desired pixel value representing a colour comprises black, white or a shade of grey between black and white.

### BRIEF DESCRIPTION OF THE DRAWINGS

These and other aspects of the invention will now be described, by way of example only, with reference to the accompanying figures in which:

FIGS. 1a and 1b show respectively, a front view and a rear view of an electronic display device;

FIG. 2 shows a detailed vertical cross-section through a display portion of the display device of FIG. 1;

FIG. 3 shows an example of a waveform for an electrophoretic display of the display device of FIG. 1;

FIG. 4 is a block diagram of control circuitry suitable for the electronic display device of FIG. 1a;

FIG. 5 is a block diagram of an intermediary module for an electronic consumer device connected to the display device;

FIG. 6 shows an example target image to be written to a display;

FIG. 7 shows a simplified flow diagram of a method of reducing a degradation in a pixel value in a display;

FIG. 8 shows the target image of FIG. 6 having an averaging filter applied thereto;

FIG. 9 shows a pixel influence map of the target image of FIG. 6;

FIG. 10 is an intermediate image generated from the pixel influence map of FIG. 9;

FIG. 11 is a compensation image for reducing the degradation in a pixel value in a display;

FIG. 12 shows simplified version of the block diagram of control circuitry of FIG. 4; and

FIG. 13 shows a more detailed view of the Driver of FIG. 12.

### DETAILED DESCRIPTION OF THE DRAWINGS

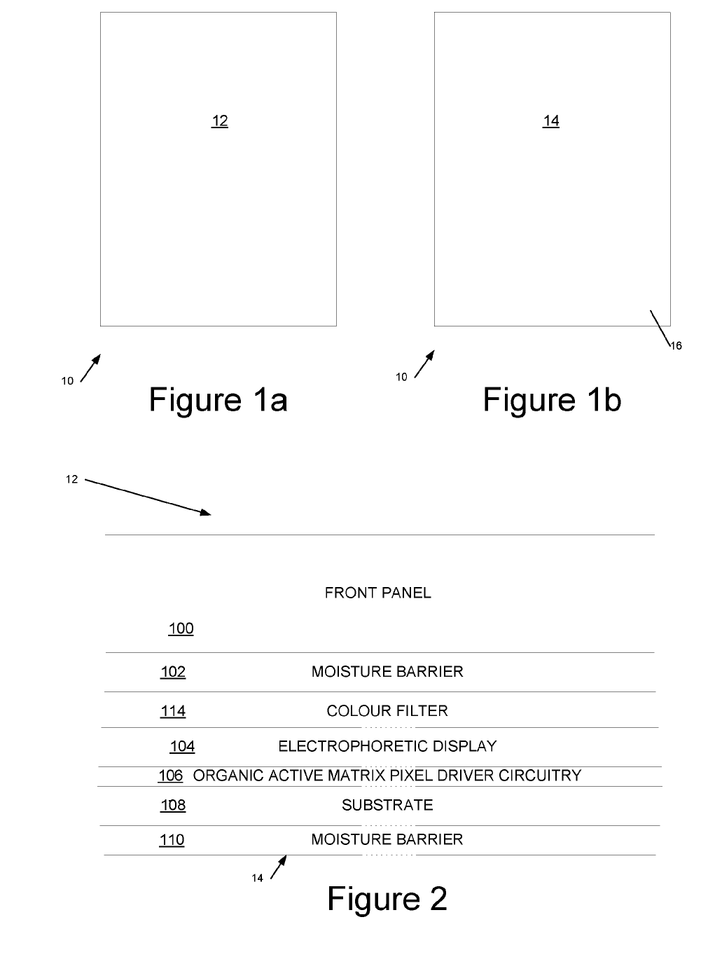

We will first discuss aspects of the display technology. FIGS. 1a and 1b schematically illustrate an electronic display device 10 having a front display face 12 and a rear face 14. The display surface 12 is substantially flat to the edges of the device and may as illustrated lack a display bezel. However, it will be appreciated that the electronic (electrophoretic) display may not extend right to the edges of the display surface 12, and rigid control electronics may be incorporated around the edges of the electronic display.

Referring now to FIG. 2, this illustrates a vertical cross-section through a display region of the device. The drawing is not to scale. The structure comprises a substrate 108, typically of plastic such as PET (polyethylene terephthalate) on which is fabricated a thin layer 106 of organic active matrix pixel driver circuitry. The active matrix pixel driver circuitry layer 106 may comprise an array of organic or inorganic thin film transistors as disclosed, for example, in WO 01/47045. Attached over this, for example by adhesive, is an electrophoretic display 104. The electrophoretic display is a display which is designed to mimic the appearance of ordinary ink on paper and may be termed electronic paper, e-paper and electronic ink. Such displays reflect light and typically the image displayed is greyscale (or monochrome).

A moisture barrier 102 is provided over the electronic display 104, for example of polyethylene and/or Aclar™, a fluoropolymer (polychlorotrifluoroethylene-PCTFE). A moisture barrier 110 is also preferably provided under substrate 108. Since this moisture barrier does not need to be transparent preferably moisture barrier 110 incorporates a metallic moisture barrier such as a layer of aluminium foil. This allows the moisture barrier to be thinner, hence enhancing overall flexibility. In preferred embodiments the device has a substantially transparent front panel 100, for example made of Perspex®, which acts as a structural member. A front panel is not necessary and sufficient physical stiffness could be provided, for example, by the substrate 108 optionally in combination with one or both of the moisture barriers 102, 110.

A colour filter 114 is optionally applied over the display. Such a filter is a mosaic of small filters placed over the pixel sensors to capture colour information and is explained in more detail below. The filter may be a RGBW (Red, Green, Blue, White) filter or another equivalent version.

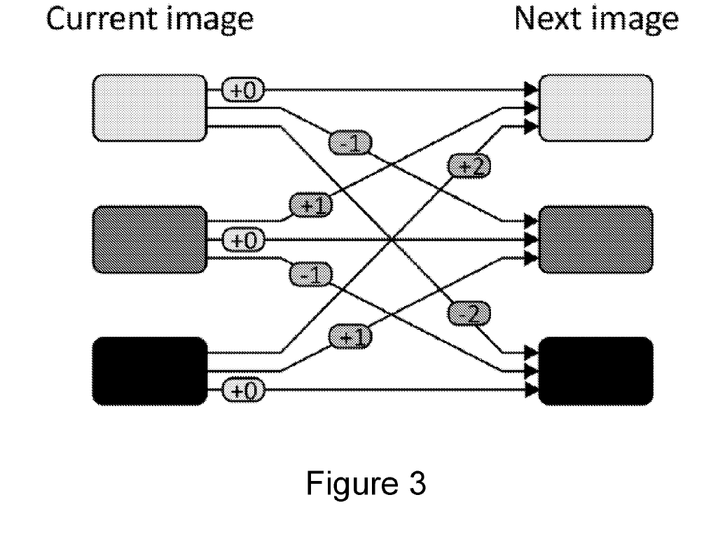

Electrophoretic display media is unlike most display technologies. When power is removed from conventional displays (such as LCD, OLED and Plasma) they revert to an off-state. This state is known and any colour can be driven accurately from this starting point. Electrophoretic displays differ since they retain the last image that was written to them. Therefore, the display must be unwritten before it is rewritten. Waveforms are set of “transitions” that tell a pixel how to change from one image to the next; essentially a guide on how to turn every grey level to every other grey level. For a display capable of three grey levels this results in a waveform with nine transitions as shown schematically in FIG. 3.

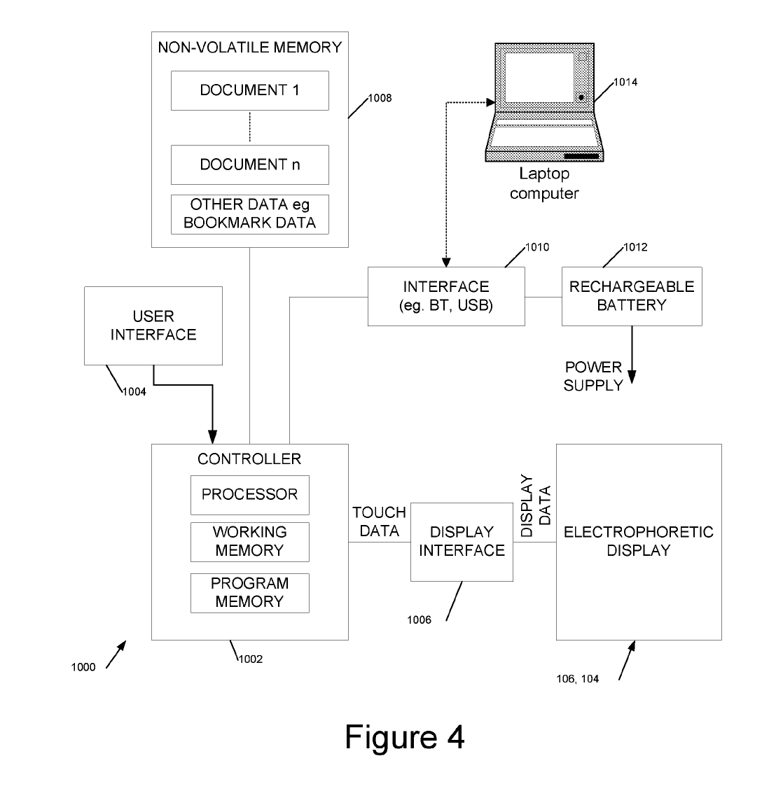

Referring now to FIG. 4, this shows example control circuitry 1000 suitable for the above-described electronic display device 10. The control circuitry comprises a controller 1002 including a processor, working memory and programme memory, coupled to a user interface 1004 for example for controls 130. The controller is also coupled to the active matrix driver circuitry 106 and electrophoretic display 104 by a display interface 1006 for example provided by integrated circuits 120. In this way controller 1002 is able to send electronic document data to the display 104 and, optionally, to receive touch-sense data from the display. The control electronics also includes non-volatile memory 1008, for example Flash memory for storing data for one or more documents for display and, optionally, other data such as user bookmark locations and the like. The skilled person will appreciate that processor control code for a wide range of functions may be stored in the programme memory.

An external interface 1010 is provided for interfacing with a computer such as laptop, PDA, or mobile or ‘smart’ phone 1014 to receive document data and, optionally, to provide data such as user bookmark data. The interface 1010 may comprise a wired, for example USB, and/or wireless, for example Bluetooth™ interface and, optionally, an inductive connection to receive power. The latter feature enables embodiments of the device to entirely dispense with physical electrical connections and hence facilitates inter alia a simpler physical construction and improved device aesthetics as well as greater resistance to moisture. A rechargeable battery 1012 or other rechargeable power source is connected to interface 1010 for recharging, and provides a power supply to the control electronics and display.

Electronic documents to be displayed on the display device may come from a variety of sources, for example a laptop or desktop computer, a PDA (Personal Digital Assistant), a mobile phone (e.g. Smart Phones such as the Blackberry™), or other such devices. Using the wired (e.g. USB etc) or wireless (e.g. Bluetooth™) interfaces, the user can transfer such electronic documents to the electronci display device in a variety of ways, e.g. using synchronisation or “printing”. Electronic documents may comprise any number of formats including, but not limited to, PDF, Microsoft Word™, Bitmaps, JPG, TIFF and other known formats.

For transfer using synchronisation, the user connects the electronic display device to a separate device (e.g. laptop or desktop computer, PDA or ‘smart’ phone) which is storing an electronic document. During this synchronisation, all of the electronic documents that are stored in any number of user-defined folders defined on the separate device, and that are not present in the memory of the reader are transferred to the reader. Similarly, any documents not present on the separate device that are present on the display device (for example, documents that have been modified or written to whilst displayed on the reader) may also be transferred back to the separate device. Alternatively, the connection interface may allow a user to specify that only a subset of the documents are to be synchronised. Alternatively, a live synchronisation may be performed, where the reader could store all documents that have been recently viewed on the separate device.

During synchronisation, the separate device takes control of the display device and transfers data to and from the reader. To understand the capabilities of the display device, the separate device may require several software components to be installed, for example, a printer driver; a reader driver (to manage the details of the communications protocol with the reader) and a controlling management application.

The incorporation of a printer driver or similar intermediary module to convert the electronic document into a suitable format for displaying on the reader allows transfer of the documents by “printing”. The intermediary module generates an image file of each page within a document being printed. These images may be compressed and stored in a native device format used by the electronic reader. These files are then transferred to the electronic reader device as part of a file synchronisation process.

One of the advantages of this “printing” technique is that it allows support for any document/file for which the operating system has a suitable intermediary module, such as a printer driver module, installed. During the file synchronisation sequence the control program looks at each document and determine whether the operating system associates an application with that file, for example, a spreadsheet application will be associated with a spreadsheet document. The control application invokes the associated application and asks it to ‘print’ the document to the printer module. The result will be a series of images in a format suitable for the electronic reader; each image corresponding to a page of the original document. These images will appear on the electronic reader, as if the document had been printed. The electronic reader may thus be termed a “paperless printer”.

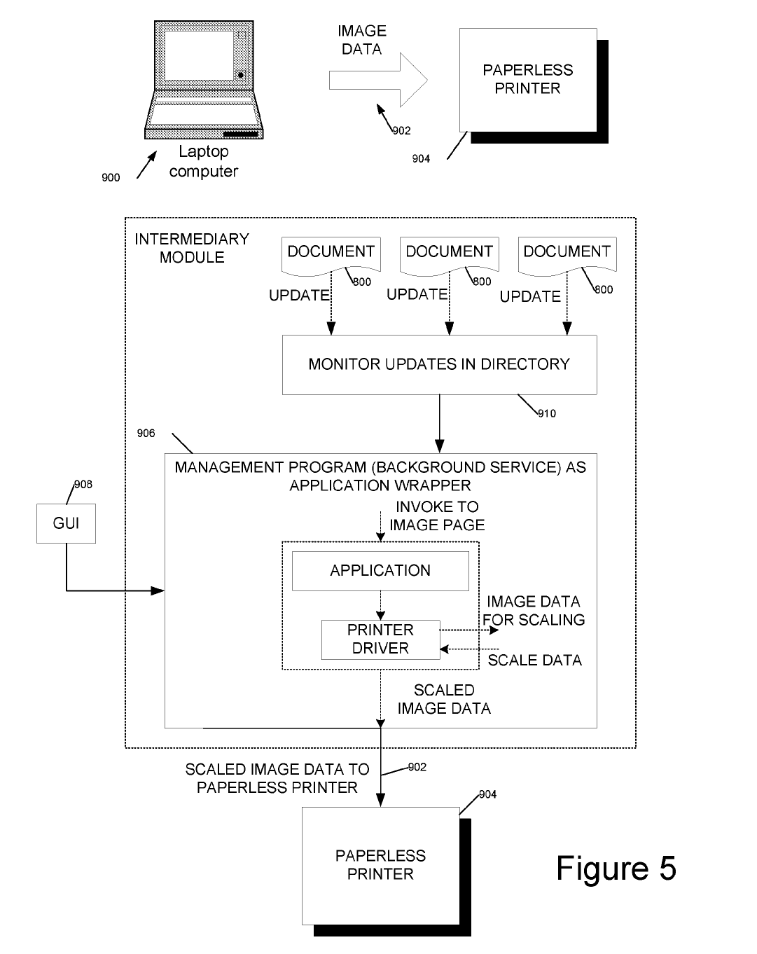

FIG. 5 schematically illustrates the components for “printing” implemented on a computerised electronic device such as a laptop computer 900, although it will be understood that other types of device may also be employed. Page image data 902 at a resolution substantially equal to that of a resolution of the electronic reader is sent to the electronic reader 904 for display. Optionally information such as annotation data representing user annotations on a paperless printer document may be transferred back from electronic reader 904 to consumer electronic device at 900, for example as part of a synchronisation procedure.

An intermediary module comprising a management program 906 preferably runs as a background service, i.e. it is hidden from a general user. The intermediary module may reside in the document reader 904 or on the electronic device 900. The processing by the intermediary module may include adjusting or cropping margins, reformatting or repaginating text, converting picture elements within a document into a suitable displayable content, and other such processes as described belo.

A graphical user interface 908 is provided, for example on a desktop of device 900, to allow a user to setup parameters of the paperless printing mechanism. A drag-and-drop interface may also be provided for a user so that when a user drags and drops a document onto an appropriate icon the management program provides a (transparent) paperless print function for the user. A monitoring system 910 may also be provided to monitor one or more directories for changes in documents 800 and on detection of a change informs the management program 906 which provides an updated document image. In this way the management program automatically “prints” documents (or at least a changed part of a document) to the electronic reader when a document changes. The image information is stored on the electronic reader although it need not be displayed immediately.

We will now discuss the problems with display technologies, for example the degradation in pixel value due to the pixel values of surrounding, or neighbouring pixels.

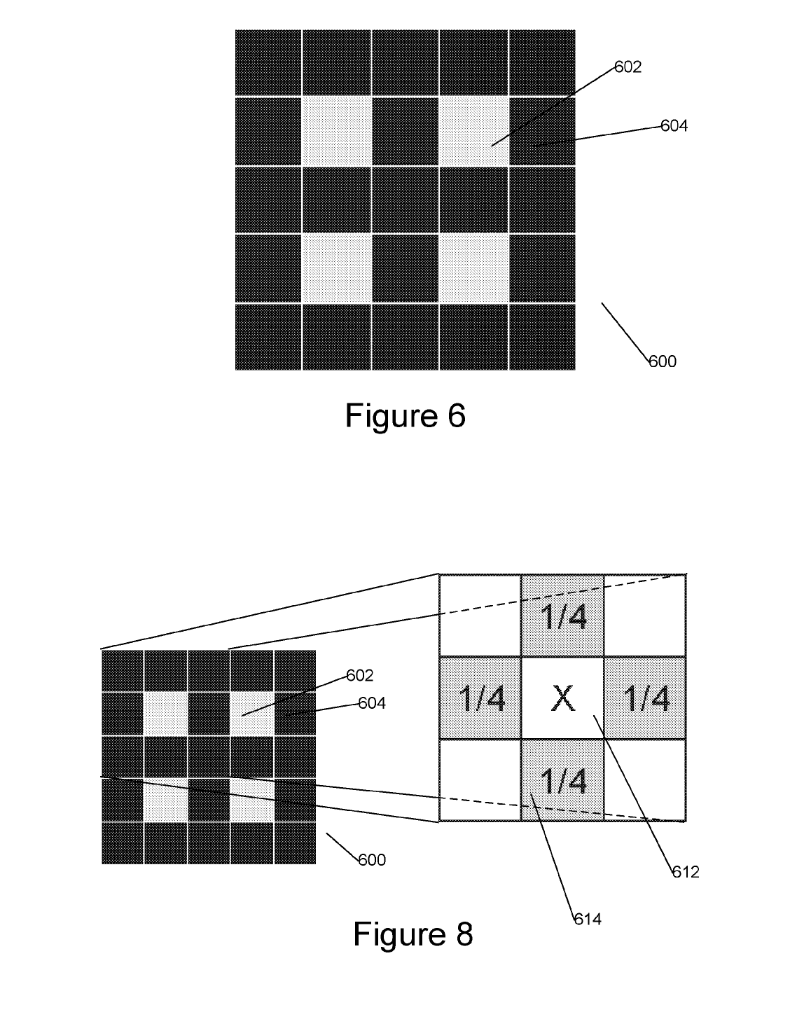

FIG. 6 shows a simplified portion of a target image 600 to be displayed on a display such as an electrophoretic display. In a colour display, this target image could, for example, relate to displaying a primary colour, for example red. In this case, the red pixels 602 are 100% (i.e. displayed as white beneath the colour filter), whereas all other pixels 604 are set to black (since electrophoretic displays are reflective, black reflects no light, whereas white reflects light back to the user).

In this target image, it has been observed that the value of pixels 602 (i.e. the red pixels) is influenced or degraded by the surrounding pixels 604 to the extent that the red pixels 602 are much less bright, or sometimes are not even visible.

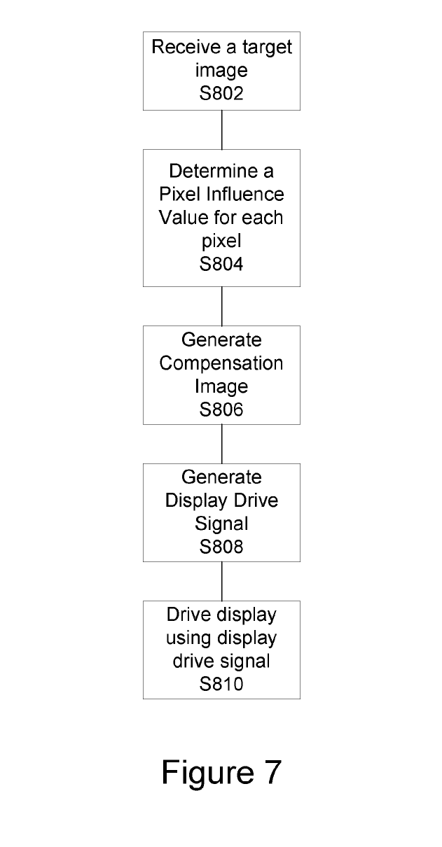

FIG. 7 is a simplified flow chart of a method of reducing degradation in a pixel value in a display that is driven to display a target image.

In the method, a target image is received at S802. The target image may comprise pixel value data for a plurality of pixels in the target image, where the pixel value data defines a desired pixel value representing a colour for a pixel in the target image. This colour may, for example, be black, white or a shade of grey in between black and white. In colour displays, this may relate to a pixel under a particular colour filter area, so the pixel is still driven to black, white or a shade of grey in between, but the pixel may display a colour due to the colour filter.

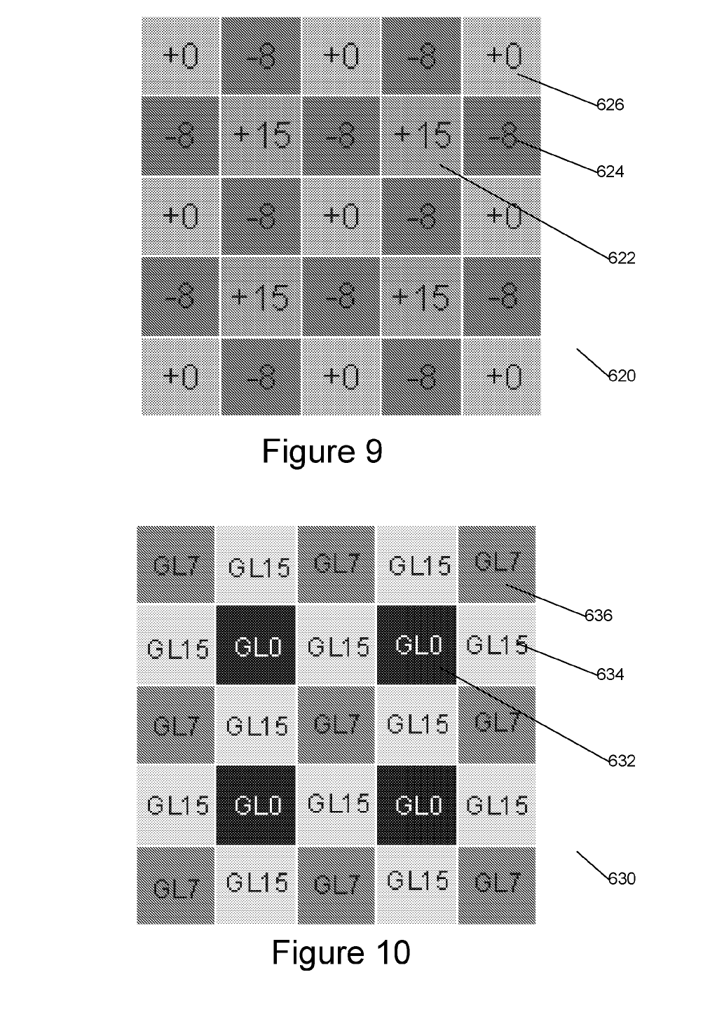

In step S804, a pixel influence value for each of the pixels in the target image is determined from the pixel value data. The pixel influence value is a relative value of how much a particular pixel is influenced by one or more neighbouring pixels. The method used to generate this pixel influence value will be discussed below with reference to FIGS. 8 and 9.

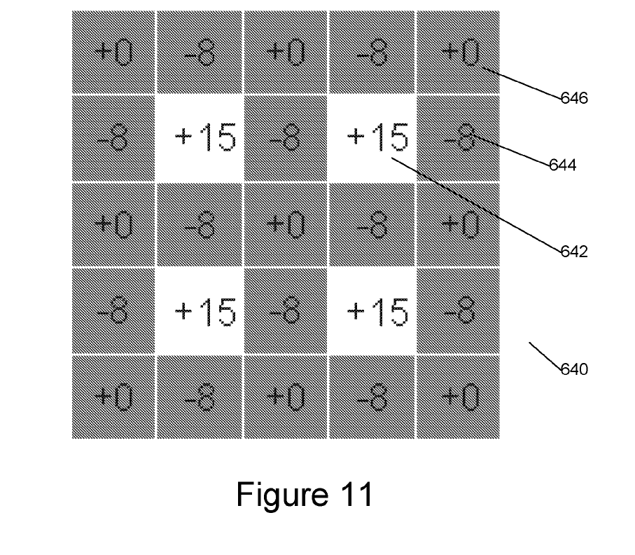

In step S806, a compensation image is generated using the pixel influence values for each of the pixels in the target image. The compensation image comprises pixel compensation value data for a plurality of pixels in the compensation image, where the pixel compensation value data represents a colour for a pixel in the compensation image. For example, the colour may be black, white or a shade of grey between black and white. The compensation image will be discussed in relation to FIG. 11.

In step S808, a display compensation drive signal is generated using the compensation image, and in step S810, the display is driven using the display compensation drive signal to display the compensation image to reduce the degradation in a pixel value.

These steps will now be discussed in more detail.

With reference to FIGS. 8 and 9, the pixel influence values are determined as follows. Firstly, for each pixel, a first target pixel value 602, 612 is compared against a second target pixel value a neighbouring pixel 604, 614 in the target image. Then, a difference between the first target pixel value and the second target pixel value is calculated.

In preferred embodiments, the second target pixel value is in fact an average target pixel value of two or more of the surrounding or neighbouring pixels to the pixel of interest. Preferably, the second target pixel value is an average of four of the pixels surrounding the pixel of interest i.e. the pixel above, below, to the left of and to the right of the pixel of interest.

Taking one of the white pixels 602 in the example shown, this will have a value of GL15. Considering the average pixel value of the surrounding pixels (each of which are black, i.e. GL0), we have:

Average pixel value=(0+0+0+0)/4=0

The Pixel influence value (PIV) is defined as:

PIV=Target value−Average Pixel value

Therefore, for pixel 602:

PIV=15−0=15

Shifting the pixel of interested to the left of pixel 602, we have:

Average pixel value=(0+15+0+15)/4=8 (rounded up to next whole integer)

Which gives:

PIV=0−8=−8

And so on for each of the pixels in the target image. Applying this averaging filter operation across the whole of the target image generates a pixel influence map 620 (shown in FIG. 9), which has pixel influence values for each of the pixels.

FIG. 9 shows an example pixel influence map 620 for a display having 16 levels of grey (from black—GL0, to white—GL15). Since this is showing an extreme case where the target image consists only of white pixels 602 surrounded by black pixels 604, the pixel influence value 622 for the white pixels is high (i.e. they are influenced heavily by the surrounding black pixels). It can also be seen that the black pixels 624 surrounding the white pixel 622 are also influenced. The positive and negative signs imply that the white pixels are influenced in that they tend to go less white, whereas the black pixels tend to go less black.

It can also be seen that some pixels 626 are not considered to have an influence value. This is as a result of filtering only pixels that neighbour the pixel in the horizontal and vertical axes. In other embodiments, the diagonals could also be taking into account, in which case these pixels may also have a pixel influence value.

Once the level of influence has been determined, we now need to construct a compensation image to take into account the influence that each pixel is experiencing due to neighbouring pixels.

Preferably, an intermediate, or ghost, image is constructed using the pixel influence values for each of the pixels in the target image. The intermediate image comprises intermediate pixel value data for a plurality of pixels in the intermediate image, where the intermediate pixel value data defines a pixel value representing a colour for a pixel in the intermediate image.

To construct the intermediate image, the pixel influence value for each pixel is compared with a threshold pixel value, and the intermediate pixel value is set dependent upon the pixel influence value relative to the threshold pixel value.

The following rules are used to determine the pixel values for the intermediate image:
if the pixel influence value is below a threshold pixel value, the intermediate pixel value is set to a substantially average pixel value between a pixel value representing black and a pixel value representing white (for example mid-grey level GL7)
if the pixel influence value is greater than a threshold pixel value and the desired pixel value represents white (i.e. GL15), the intermediate pixel value is set to a pixel value representing black (i.e. GL0)
if the pixel influence value is greater than a threshold pixel value and the desired pixel value represents black (i.e. GL0), the intermediate pixel value is set to a pixel value representing white (i.e. GL15)

Given the example values in the pixel influence map shown in FIG. 9, the pixel values are converted to the intermediate pixel values as shown:
Pixels with 0 value>set to GL7 (mid-grey)
Pixels with −8 value>set to GL15 (white)
Pixels with +15 value>set to GL0 (black)

Once the intermediate image has been created, this is stored in a buffer and used to construct a sequence of drive signals to drive a display. This sequence of drive signals is the compensation image. As discussed above, the drive signals are waveforms taken from a known list of transitions from one level of grey to another level of grey.

Using the data in the intermediate image, the drive signals are created to drive the signal from the value given in the intermediate image to the desired target value. Since pixels with the GL7 (mid-grey) level are considered to have been influenced little by the surrounding pixels, there is no need to drive these pixels again, so a null state or value is set. These pixels are not driven in the compensation image.

As such, the method preferably only constructs a driving signal based on the pixels in the intermediate image that have values of GL15 and GL0. That is, for each pixel have a GL15 or GL0 value, a drive signal is selected from a plurality of drive signals depending on the intermediate pixel value and the pixel influence value, which provides drive signals to drive the intended pixels further to compensate for the degree to which they are influenced.

In practice, a plurality of waveforms are stored for defined transitions, for example, a waveform defining the steps or number of pulses required to drive a pixel set to GL15 when the pixel influence value is −8. Or a waveform defining the steps or number of pulses required to drive a pixel set to GL0 when the pixel influence value is +15. And so on for all transitions from GL0 and GL15 to each possible pixel influence value.

This results in the compensation image as shown in FIG. 11.

Preferably, the compensation image is sent to the display after the target image is written to the display. Broadly speaking, the above-described method enables pixels that have already been driven to a particular value to be driven again (sometimes ‘harder’, depending on the required transitions), to compensate for the expected degradation caused by the influence of neighbouring pixels. That is, white pixels are driven more white, and black pixels are driven more black.

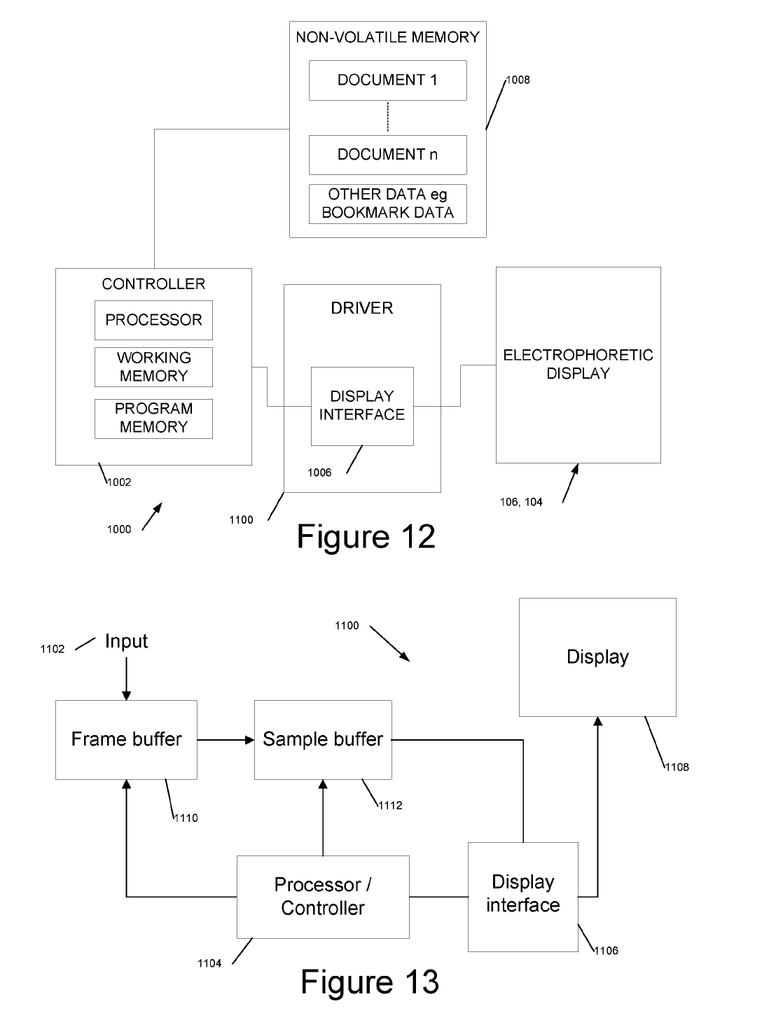

FIG. 12 shows a simplified view of the block diagram of FIG. 4. In this figure, like features use the same reference numerals. As with FIG. 4, pre-rendered or pre-processed documents (comprising, for example, target images comprising pixel value data) are stored in non-volatile memory 1008, which is coupled to a controller 1002. The controller sends data to the driver 1100, which comprises a display interface and which generates appropriate drive signals to drive the display 106.

FIG. 13 shows a more detailed view of the driver 1100 of FIG. 12. Its operation will now be discussed.

The display driver 1100 is configured to reduce degradation in a pixel value in a target image that is displayed on the display 106. The driver 1100 comprises an input 1102 for receiving a target image comprising pixel value data for a plurality of pixels in the target image. The pixel value data defines a desired pixel value representing a colour for a pixel in the target image, for example black, white or a shade of grey in between black and white. In embodiments, there are 16 levels of grey between black and white. As above, the display 106 can comprise a colour filter to provide a colour display.

The driver 1100 also comprises an output for outputting a display driving signal to the display 106 and a processor or controller 1104. The processor 1104 is configured to generate a compensation image for displaying on the display for reducing the degradation in the pixel value.

The processor is configured to operate the above-described method, so the processor 1104 is configured to determine a pixel influence value for each of the pixels in a received target image from the pixel value data. Furthermore, the processor 1104 is also configured to generate a compensation image using the pixel influence value for each of the pixels in the target image, where the compensation image comprising pixel compensation value data for a plurality of pixels in the compensation image, and where the pixel compensation value data defines a desired pixel value representing a colour for a pixel in the compensation image.

Once the compensation image has been generated, the processor 1104 generates a display compensation drive signal using the compensation image, and drives the display using the display compensation drive signal to display the compensation image to reduce the degradation in a pixel value.

In order for the display driver 1100 to generate the appropriate drive waveforms to reduce the degradation to the pixel value, the controller, for each pixel in the intermediate image having an intermediate pixel value that represents black, a waveform is selected to drive a pixel from black to the desired pixel value in the target frame. Likewise, the processor, for each pixel in the intermediate image having an intermediate pixel value that represents white, selects a drive waveform to drive a pixel from white to the desired pixel value in the target frame.

It is noted that, prior to determining a pixel influence value, the display driver generates a display drive signal using the target image and drives the display to display the target image.

In embodiments, the processor 1104 is configured to generate a display drive signal using the target image by, for each pixel value in the target image, comparing the target image pixel value with a current pixel value being displayed on the display and selecting a drive waveform from a plurality of waveforms for driving a pixel from the current pixel value being displayed on the display to the desired pixel value in the target image.

In order to achieve this, the display driver is provided with a frame buffer 1110 and a sample buffer 1112. The processor stored the received target image in the frame buffer, and stores the currently-displayed image in the sample buffer. The processor then compares the images in the frame and sample buffer to determine, for each pixel in the target image, which drive waveform is required to transition the pixel from the current pixel value to the desired target value.

The above embodiments have been described where the processing of the target image and generation of the compensation image are carried out within the electronic document reading device.

In alternative embodiments, it is envisaged that processing may occur outside of the device, for example during the electronic printing stage, to alleviate the processor of the additional processing required to obtain the compensation image.

Furthermore, additional alternative embodiments are envisaged where there is no need for an intermediate or ghost image to be created. In such an embodiment, the processor (whether local to the document reader, or outside the document reader, for example in the printing module) adjusts the drive waveforms for the target image to take into account the expected pixel influence values prior to transmitting the target image. Such an embodiment clearly has advantages in that only a single frame is required to be sent to the device (reducing the time take to display the image). However, this comes at a cost of additional processing power required to process the image.

No doubt many other effective alternatives will occur to the skilled person. It will be understood that the invention is not limited to the described embodiments and encompasses modifications apparent to those skilled in the art lying within the spirit and scope of the claims appended hereto.

1. A method of reducing degradation in a pixel value in a display that is driven to display a target image, comprising the steps of:
receiving a target image comprising pixel value data for a plurality of pixels in the target image, the pixel value data defining a desired pixel value representing a colour for a pixel in the target image;
determining a pixel influence value for each of the pixels in the target image from the pixel value data;
generating a compensation image using the pixel influence value for each of the pixels in the target image, the compensation image comprising pixel compensation value data for a plurality of pixels in the compensation image, the pixel compensation value data representing a colour transition for a pixel in the compensation image;
generating a display compensation drive signal using the compensation image; and
driving a display using the display compensation drive signal to display the compensation image to reduce the degradation in a pixel value.

2. A method according to claim 1, wherein the step of determining a pixel influence value comprises:
for each pixel, comparing a first target pixel value of the pixel of interest with a second target pixel value of a neighbouring pixel in the target image; and
determining a difference between the first target pixel value and the second target pixel value.

3. A method according to claim 2, wherein the second target pixel value comprises a mean target pixel value of two or more neighbouring pixels in the target image.

4. A method according to claim 2, wherein a neighbouring pixel is a pixel that is above, below, to the left or to the right of the pixel of interest.

5. A method according to claim 1, wherein the step of generating a compensation image comprises generating an intermediate image using the pixel influence value for each of the pixels in the target image, the intermediate image comprising intermediate pixel value data for a plurality of pixels in the intermediate image, the intermediate pixel value data defining a pixel value representing a colour for a pixel in the intermediate image.

6. A method according to claim 5, wherein the step of generating an intermediate image comprises:
comparing the pixel influence value for each pixel with a threshold pixel value; and
setting an intermediate pixel value dependent upon the pixel influence value relative to the threshold pixel value.

7. A method according to claim 6, wherein if the pixel influence value is below a threshold pixel value, the intermediate pixel value is set to a substantially average pixel value between a pixel value representing black and a pixel value representing white.

8. A method according to claim 6, wherein if the pixel influence value is greater than a threshold pixel value and the desired pixel value is whiter, the intermediate pixel value is set to a pixel value representing black.

9. A method according to claim 6, wherein if the pixel influence value is greater than a threshold pixel value and the desired pixel value is more black, the intermediate pixel value is set to a pixel value representing white.

10. A method according to claim 7, wherein the step of generating a display compensation drive signal comprises:
for each pixel in the intermediate image having an intermediate pixel value that is substantially average, setting a null state so that no drive signal is provided.

11. A method according to claim 7, wherein the step of generating a display compensation drive signal comprises:
for each pixel in the intermediate image having an intermediate pixel value that represents black or white, selecting a first drive waveform from a plurality of waveforms based on the intermediate pixel value and the pixel influence value.

12. A method according to claim 11, wherein the first drive waveform defines a driving signal to drive a display based on a transition from black or white to a second pixel value dependent on the pixel influence value.

13. A method of driving a display to display a target image, comprising:
receiving a target image comprising pixel value data for a plurality of pixels in the target image, the pixel value data defining a desired pixel value representing a colour for a pixel in the target image; and
reducing degradation in a pixel value in the target image using the method according to claim 1, wherein the compensation drive signal is a display drive signal.

14. A method of driving a display to display a target image, comprising:
receiving a target image comprising pixel value data for a plurality of pixels in the target image, the pixel value data defining a desired pixel value representing a colour for a pixel in the target image;
generating a display drive signal using the target image;
driving a display using the display drive signal to display the target image;
reducing degradation in a pixel value in the displayed target image using the method according to claim 1.

15. A method according to claim 13, wherein the step of generating a display drive signal using the target image comprises, for each pixel value in the target image:
comparing the target image pixel value with a current pixel value being displayed on the display;
selecting a drive waveform from a plurality of waveforms for driving a pixel from the current pixel value being displayed on the display to the desired pixel value in the target image.

16. A method according to claim 15, wherein the step of receiving a target image comprises storing the received target image in a frame buffer, and wherein the step of comparing the target image pixel value with the current pixel value comprises comparing the target image pixel value stored in the frame buffer with the current pixel value.

17. A method according to claim 15, comprising storing the current pixel value being displayed on the display in a sample buffer, and wherein the step of comparing the target image pixel value with the current pixel value comprises comparing the target image pixel value with the current pixel value stored in the sample buffer.

18. A method according to claim 1, wherein the display is an electrophoretic display.

19. A method according to any procceding claim 1, wherein the desired pixel value representing a colour comprises black, white or a shade of grey between black and white.

20. A display driver for reducing degradation in a pixel value in a display that is driven to display a target image on a display coupleable to the display driver, the display driver comprising:
an input for receiving a target image comprising pixel value data for a plurality of pixels in the target image, the pixel value data defining a desired pixel value representing a colour for a pixel in the target image;
an output for outputting a display driving signal to a display coupleable to the display driver to display a compensation image to reduce the degradation in a pixel value; and
a processor coupled to the input and output, and configured to generate a compensation image for displaying on a display coupleable to the display driver for reducing the degradation in a pixel value, wherein the processor is configured to:
determine a pixel influence value for each of the pixels in a received target image from the pixel value data;
generate a compensation image using the pixel influence value for each of the pixels in the target image, the compensation image comprising pixel compensation value data for a plurality of pixels in the compensation image, the pixel compensation value data defining a desired pixel value representing a colour transistion for a pixel in the compensation image;
generate a display compensation drive signal using the compensation image; and
drive a display coupleable to the display driver using the display compensation drive signal to display the compensation image to reduce the degradation in a pixel value.

21. A display driver according to claim 20, wherein the processor is configured to generate a compensation image by:
for each pixel, comparing a first target pixel value of the pixel of interest with a second target pixel value of a neighbouring pixel in the target image; and
determining a difference between the first target pixel value and the second target pixel value.

22. A display driver according to claim 21, wherein the second target pixel value comprises a mean target pixel value of two or more neighbouring pixels in the target image.

23. A display driver according to claim 21, wherein a neighbouring pixel is a pixel that is above, below, to the left or to the right of the pixel of interest.

24. A display driver according to claim 20, wherein the processor is configured to generate a compensation image by:
generating an intermediate image using the pixel influence value for each of the pixels in the target image, the intermediate image comprising intermediate pixel value data for a plurality of pixels in the intermediate image, the intermediate pixel value data defining a pixel value representing a colour for a pixel in the intermediate image.

25. A display driver according to claim 24, wherein the processor is configured to generate an intermediate image by:
comparing the pixel influence value for each pixel with a threshold pixel value, and setting an intermediate pixel value dependent upon the pixel influence value relative to the threshold value.

26. A display driver according to claim 25, wherein if the pixel influence value is below a threshold pixel value, the processor is configured to set the intermediate pixel value to a substantially average pixel value between a pixel value representing black and a pixel value representing white.

27. A display driver according to claim 25, wherein if the pixel influence value is greater than a threshold pixel value and the desired pixel value is whiter, the processor is configured to set the intermediate pixel value to a pixel value representing black.

28. A display driver according to claim 25, wherein if the pixel influence value is greater than a threshold pixel value and the desired pixel value is more black, the processor is configured to set the intermediate pixel value to a pixel value representing white.

29. A display driver according to claim 26, wherein the processor is configured to generate a display compensation drive signal by:
for each pixel in the intermediate image having an intermediate pixel value that is substantially average, setting a null state so that no drive signal is provided.

30. A display driver according to claim 26, wherein the processor is configured to generate a display compensation drive signal by:
for each pixel in the intermediate image having an intermediate pixel value that represents black or white, selecting a first drive waveform from a plurality of waveforms based on the intermediate pixel value and the pixel influence value.

31. A display driver according to claim 26, wherein the first drive waveform defines a driving signal to drive a display based on a transition from black or white to a second pixel value dependent on the pixel influence value.

32. A display driver according to claim 20, wherein the processor, prior to determining a pixel influence value, is configured to:
generate a display drive signal using the target image;
drive a display coupleable to the display driver using the display drive signal to display the target image.

33. A display driver according to claim 32, wherein the processor is configured to generate a display drive signal using the target image by, for each pixel value in the target image:
comparing the target image pixel value with a current pixel value being displayed on the display;
selecting a drive waveform from a plurality of waveforms for driving a pixel from the current pixel value being displayed on the display to the desired pixel value in the target image.

34. A display driver according to claim 33, comprises a frame buffer, wherein the processor is configured to store the received target image in the frame buffer, and wherein the processor is configured to compare the target image pixel value stored in the frame buffer with the current pixel value.

35. A display driver according to claim 33, comprising a sample buffer, wherein the processor is configured to store the current pixel value being displayed on a display coupleable to the display driver in the sample buffer, and wherein the processor is configured to compare the target image pixel value with the current pixel value stored in the sample buffer.

36. An electronic display device comprising:
a display; and
the display driver according to claim 20 coupled to the display.

37. A display driver or an electronic reading device according to claim 20, wherein the display is an electrophoretic display.

38. A display driver or an electronic reading device according to claim 20, wherein the desired pixel value representing a colour comprises black, white or a shade of grey between black and white.

39. A method according to claim 14, wherein the step of generating a display drive signal using the target image comprises, for each pixel value in the target image:
comparing the target image pixel value with a current pixel value being displayed on the display;
selecting a drive waveform from a plurality of waveforms for driving a pixel from the current pixel value being displayed on the display to the desired pixel value in the target image.

40. A method according to claim 39, wherein the step of receiving a target image comprises storing the received target image in a frame buffer, and wherein the step of comparing the target image pixel value with the current pixel value comprises comparing the target image pixel value stored in the frame buffer with the current pixel value.

41. A method according to claim 39, comprising storing the current pixel value being displayed on the display in a sample buffer, and wherein the step of comparing the target image pixel value with the current pixel value comprises comparing the target image pixel value with the current pixel value stored in the sample buffer.

42. A method according to claim 13, wherein the display is an electrophoretic display.

43. A method according to claim 14, wherein the display is an electrophoretic display.

44. A method according to claim 13, wherein the desired pixel value representing a colour comprises black, white or a shade of grey between black and white.

45. A method according to claim 14, wherein the desired pixel value representing a colour comprises black, white or a shade of grey between black and white.
